(19) United States
(12) Patent Application Publication
(10) Pub. No.: US 2025/0390415 A1
(43) Pub. Date: Dec. 25, 2025

(54) DETERMINISTIC AUTOMATED INFRASTRUCTURE AS CODE REMEDIATION

(71) Applicant: Gomboc.AI Inc., New York, NY (US)

(72) Inventors: Ian Amit, New York, NY (US); Matthew Sweeney, New York, NY (US)

(21) Appl. No.: 19/244,883

(22) Filed: Jun. 20, 2025

Related U.S. Application Data
(60) Provisional application No. 63/662,976, filed on Jun. 21, 2024.
(60) Provisional application No. 63/662,973, filed on Jun. 21, 2024.

(51) Int. Cl. G06F 11/3604

(52) U.S. Cl. CPC G06F 11/3608

(57) ABSTRACT

A computer-implemented method of automatic infrastructure as code (IaC) remediation. The method includes encoding one or more policy statements and parsing IaC code to generate resources and configuration sets for the IaC code. The method includes intersecting the encoded one or more policy statements with the resources and configuration sets. The method includes identifying one or more non-compliant IaC resources based on differentiations between the encoded one or more policy statements with the resources and configuration sets. The method includes generating remediated IaC code to remediate identified non-compliant IaC code. The method includes verification that remediated IaC code fixes the intended issue.

### CROSS-REFERENCE TO RELATED APPLICATIONS

This application claims priority to U.S. Provisional App. No. 63/662,973, filed Jun. 21, 2024, and U.S. Provisional App. No. 63/662,976, filed Jun. 21, 2024, the disclosures of which are incorporated by reference herein in their entirety.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Infrastructure as Code (IaC) is a method of managing and provisioning computing infrastructure (e.g., servers, virtual machines, containers, disk storage, databases, etc.) through machine-readable definition files. Infrastructure resources may be defined in code (e.g., JSON, YAML) and deployed using an IaC tool. The code may then be changed or updated as needed. Traditionally, when code is updated, it must be manually checked to ensure that it adheres to policy statements or other business rules, such as security policies (e.g., encryption, passwords, tokens, etc.). Additionally, even if security or other problems are identified with existing code, remediation of that code may require manual intervention to remove the offending code and rewrite it to comply with the policies.

While traditional manual approaches to code remediation are labor intensive, machine learning approaches are fallible because they tend to be statistically-based and thus non-deterministic. But their non-deterministic nature may create security risks because it cannot be ensured that the code complies with the applicable security policies.

Further aspects of the disclosure will become apparent as the following description proceeds and the features of novelty, which characterize this disclosure, are pointed out with particularity in the claims annexed to and forming a part of this specification.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a framework for programmatically identifying non-compliant infrastructure as code (IaC) and producing remediation of that code automatically without the need for new code to be produced manually. In other words, the system may identify IaC that is not compliant with business rules (e.g., security policies), produce code that fits contextually into the IaC and complies with applicable business rules, and deploy the updated code with little or no manual intervention.

In some embodiments, the disclosure describes making a programmatic deterministic translation between a programmatic security policy statement (or a collection of statements) that uses ontological definitions to produce a deterministic remediation generating function. Those functions may be applied to existing code or new code to allow for efficient implementation of security policies across an entire IaC framework.

In some embodiments, the disclosure describes a method of automatic infrastructure as code (IaC) remediation. The method may include retrieving a schema file for one or more IaC providers, where the schema files may include IaC code. The method may include parsing, by one or more processors, the one or more schema files into sets of nodes and edges. The method may include capturing, by the one or more processors, schema attribute information for each of the schema files. The method may include generating, by the one or more processors, a graph representation of the schema files based on the parsed nodes and edges and the schema attribute information. The method may include identifying one or more sets of business rules and linking, by the one or more processors, the graph representation of the schema files with the one or more sets of business rules. The method may include generating, by the one or more processors, a conflict matrix based on one or more differentiations between the graph representations of the schema files and the one or more sets of business rules. The method may include verifying, by the one or more processors, an outcome of applying a code change based on the one or more differentiations. Based on the verification, the method may include generating code changes for the IaC code

In another embodiment, the disclosure describes a computer-implemented method of automatic infrastructure as code (IaC) remediation. The method may include encoding one or more policy statements and parsing IaC code to generate resources and configuration sets for the IaC code. The method may include intersecting the encoded one or more policy statements with the resources and configuration sets. The method may include identifying one or more non-compliant IaC resources based on differentiations between the encoded one or more policy statements with the resources and configuration sets. The method may include verifying, by the one or more processors, an outcome of applying a code change based on the differentiations. The method may include generating remediated IaC code to remediate identified non-compliant IaC code.

In another embodiment, the disclosure describes a method of automatic infrastructure as code (IaC) remediation. The method may include retrieving a schema file for one or more IaC providers, where the schema files may include IaC code. The method may include parsing, by one or more processors, the one or more schema files into sets of nodes and edges. The nodes may be one or more resources of the IaC code and the edges may be relationships between the one or more resources. The method may include storing, by the one or more processors, the sets of nodes and edges in structured datasets. The method may include capturing, by the one or more processors, schema attribute information for each of the schema files. The method may include generating, by the one or more processors, a graph representation of the schema files based on the parsed nodes and edges and the schema attribute information. The method may include identifying one or more sets of business rules and generating, by the one or more processors, a set of capabilities for the one or more sets of business rules. The method may include encoding, by the one or more processors, a valid expected state of the IaC code for each capability in the set of capabilities as an expected graph. The method may include linking, by the one or more processors, the graph representation of the schema files with the one or more sets of business rules by comparing the graph representation of the schema files with the expected graph. The method may include generating, by the one or more processors, a conflict matrix based on one or more differentiations between the graph representation of the schema files with the expected graph. The method may include verifying, by the one or more processors, an outcome of applying a code change by analyzing the expected graph compared to the graph representation of the schema files. Based on the differentiations in the conflict matrix, the method may include generating code changes for the IaC code.

### BRIEF DESCRIPTION OF THE DRAWINGS

The novel features that are considered characteristic of the disclosure are set forth with particularity in the appended claims. The invention itself; however, both as to its structure and operation together with the additional objects and advantages thereof are best understood through the following description of one or more embodiments of the present disclosure when read in conjunction with the accompanying drawings. The components in the figures are not necessarily to scale, emphasis instead being placed upon illustrating the principles of the disclosure. In the figures, like reference numerals designate corresponding parts throughout the different views, wherein:

FIG. 1 is a flow chart showing an embodiment of a method for operating a deterministic automated IaC remediation as shown and described herein;

FIG. 2 is a flow chart showing another embodiment of a method for operating a deterministic automated IaC remediation as shown and described herein;

FIG. 3 is a flow chart showing another embodiment of a method for operating a deterministic automated IaC remediation as shown and described herein;

FIG. 4 is a flow chart showing another embodiment of a method for operating a deterministic automated IaC remediation as shown and described herein;

FIG. 5 is a schematic illustration of elements of an embodiment of an example computing device; and

FIG. 6 is a schematic illustration of elements of an embodiment of a server type computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure will now be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Throughout the disclosure and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Generally, the statistical nature of machine learning-based algorithms makes them non-deterministic. In some instances, this non-deterministic nature may result in security risks if such models may be used to automatically cure compliance gaps in infrastructure as code. Traditionally, expert systems may be heavily rules-based, meaning such systema may not scale well for implementation. In some embodiments, the deterministic automated IaC remediation systems and methods disclosed herein may implement a deterministic algorithm (i.e., not statistically based) that may operate using fewer rules implementations as compared to traditional methods, which may make compliance coverage significantly higher than the alternative and to traditional methods. Accordingly, in some embodiments, the disclosure IaC remediation system and methods may provide a technical solution to the technical problem of automatically identifying and remediating problematic IaC in view of business rules, particularly business rules that may be updated or otherwise change. Additionally, in some embodiments, the disclosed system may provide a specific technical solution for accurately interpreting business rules and existing IaC in a manner that may be digested and understood by a computer system, automatically comparing the digested business rules to the existing IaC to identify problematic IaC in view of the business rules, and providing remediation for the problems identified.

Further, traditional approaches to IaC remediation are labor intensive and traditional machine learning approaches may be fallible. The translation of, for example, business rules such as a security policy or best practices into code and vice-versa may also be labor intensive. For example, for each line of security “policy as code” that is written, a new audit surface area may be created for security teams to ensure that the policy checks align with expectations. Traditional attempts to address this may often rely on templates to establish best practices moving forward and cannot be applied to existing code. Conversely, in some embodiments, the deterministic automated IaC remediation methods and systems described herein may enable, for example, application of a security policy to both new and to existing code while providing fixes to that code in context of the specific application.

In some embodiments, IaC may be implemented or stored in a version control system (VCS) or other cloud computing or storage resource. In some embodiments, the deterministic automated IaC remediation methods and systems may run in the local environment where the IaC may be stored, or may run on other remote computing systems, servers, or cloud systems. For example, in some embodiments, the systems and methods may operate via cloud-storage systems or other remote servers on IaC that may be stored in its own server environment or cloud computing environment.

In some embodiments, the disclosure describes a framework for programmatically identifying non-compliant IaC and producing remediation of that code automatically without the need for new code to be produced manually. In some embodiments, the system and methods may include using ontological definitions of infrastructure as code features (i.e. capabilities) as part of the system's input as well as rule generating functions. In some embodiments, the system may include a remediation function that may apply compliant remediations to identified non-compliant code. In some embodiments, the rule generating function may produce compliance rules automatically from minimal input, an may scalably produce a large set of rules to increase compliance coverage more easily and more efficiently.

IaC is a formal language and therefore may enable programmatic and deterministic algorithmic analysis. However, the formal code itself may only provide configuration and instantiation of infrastructure resources and objects that may not take into account other business rules, such as security compliance. Security compliance, for example, may include a collection of business rules that further constraints the sets of possible IaC configurations and instantiations. Traditional rules-based compliance engines may include a specific set of labor-intensive business rules which tend to be error prone and fallible. In contrast, traditional machine learning based approaches tend to be statistically driven and therefore fallible as well.

In some embodiments, the disclosed system may identify IaC that is not compliant with business rules or policy statements (e.g., security policies), produce code that fits contextually into the IaC and complies with applicable business rules, and deploy the updated code with little or no manual intervention. In some embodiments, the disclosure describes a method and systems for making a programmatic deterministic translation between a programmatic security policy statement (or a collection of statements) that may use ontological definitions to produce one or more deterministic remediation generating function. In some embodiments, those remediating functions may be applied to existing code or to new code to allow for efficient implementation of security policies, for example, across an entire IaC framework. While, in some embodiments, creating policy statements may still be a manual process, in some embodiments, each such statement may automatically produce multiple cases of remediations from the whole framework itself.

In some embodiments, the deterministic automated IaC remediation method and systems described herein may include applying logical inferences to the ontological constructs that make up policy statements, such as security policies. In some embodiments, such ontologies may help in creating a common vocabulary and establishing relationships between different concepts, such as IaC and policy statements. Application of the logical inferences may be accomplished by constructing code into the contextual scenarios representing each logical construct. In some embodiments, data may be entered to encode the valid state expected based on the business rules. In some embodiments, each individual data entry may encode a specific rule that may translate into a specific parametrization of the IaC program at issue. Such encoding may represent a pattern from a policy schema that may be automatically transformed into an expected related pattern from an instance of infrastructure as code.

In some embodiments, the disclosed system may also include executing one or more algorithms against the encoded instance to check for partial or complete pattern matches between the IaC source file and the expected related pattern. When a complete pattern match may be identified, an assessment of compliance with the policy may be achieved. Otherwise, when a match may not be achieved between the IaC source file and the expected related pattern, the system may prescribe a value update that may put the IaC into compliance. In some embodiments, if partial matches may be identified, the system may prescribe and generate a full set of file mutation to update the IaC source file into compliant code.

In some embodiments, infrastructure as code may be a schema-defined formal language. The structure of schema-valid infrastructure as code may be validated with a schema, such as XML schema for XML data or JSON schema for JSON data. However, traditionally, schema validation may only provide binary information about valid or invalid code and, although it may offer hints as to the source of invalidity, it may not provide specific instructions to render the code valid. Additionally, schema validation may not validate relating to compliance with externally defined business rules. For example, a JSON scalar string may be schema validated as being a proper string and may further constraint subset of valid strings, but he JSON scalar string may not easily encode a proper exact value for the string and may not provide programmatic instruction as to how to update the JSON to bear the correct values. In some embodiments, the disclosed system may implement methods for achieving schema validation by applying logical inferences to ontological constructs rendered by constructing the code into the contextual scenarios representing each logical construct in the application. In some embodiments, a valid state expected may be encoded, and each individual data entry may encode a specific rule that may translate into a specific parametrization of an infrastructure as code program.

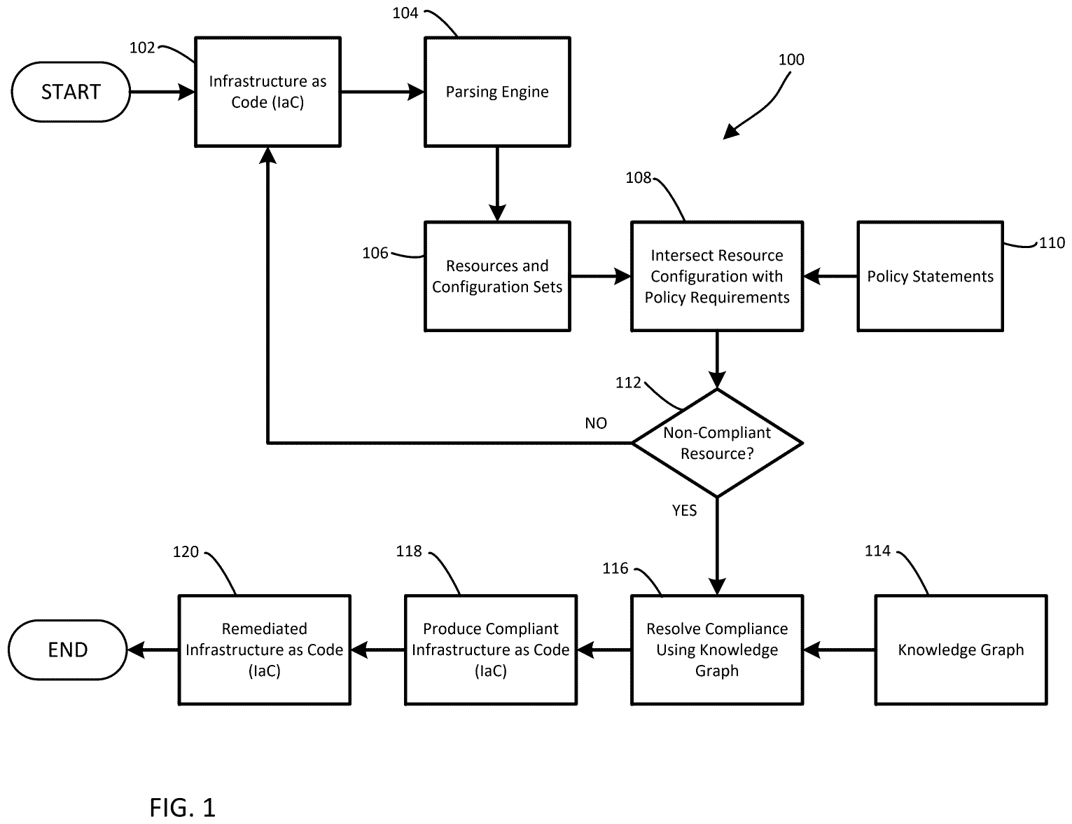

FIG. 1 shows an example flow chart representing an embodiment 100 of the deterministic automated IaC remediation method. In some embodiments, the steps of the method may be implemented by one or more processors on one or more computers or servers, and may be completed automatically with little or no manual input. In some embodiments, manual input may be provided for one or more steps of the method, or to confirm or verify one or more steps or features of the method. In some embodiments, the IaC 102 may be parsed with a parsing engine at 104. The IaC 102 may be from virtually any of a variety of IaC use cases including provisioning of virtual machines, deploying networks, database setup, web application deployment, etc. In some embodiments, the parsing engine 104 may analyze the IaC 102, such as by conducting syntax analyses, semantic analyses, etc. In some embodiments, the parsing engine 104 may configure the IaC 102 into relevant resources and configuration sets 106. In some embodiments, IaC resources may include components and entities defined within the IaC scripts that represent the infrastructure at issue, such as compute resources, storage resources, networking resources, security resources, monitoring and logging resources, etc. IaC configuration sets may include collections of configuration files and scripts that may define the desired state of the infrastructure, and may be used to automate the provisioning, management, and deployment of infrastructure resources in a consistent and repeatable manner. At 108, the resource and configuration sets 106 may then be intersected with the policy statements 110 that may have been encoded as described herein. For example, logical inferences may be applied to the ontological constructs that make up the policy statements 110, which may be used to create a common vocabulary and establish relationships between different concepts. Application of the logical inferences identified may be accomplished by constructing code into the contextual scenarios representing each logical construct. In some embodiments, a valid state expected of the IaC may be encoded based on the logical inferences drawn from the policy statement. In some embodiments, individual data entry may encode a specific rule that may translate into a specific parametrization of the IaC program at issue. Such encoding may represent a pattern from a policy schema that the system may automatically transform into an expected related pattern from an instance of infrastructure as code pertaining to the policy. In some embodiments, the expected related pattern may take to form an expected graph.

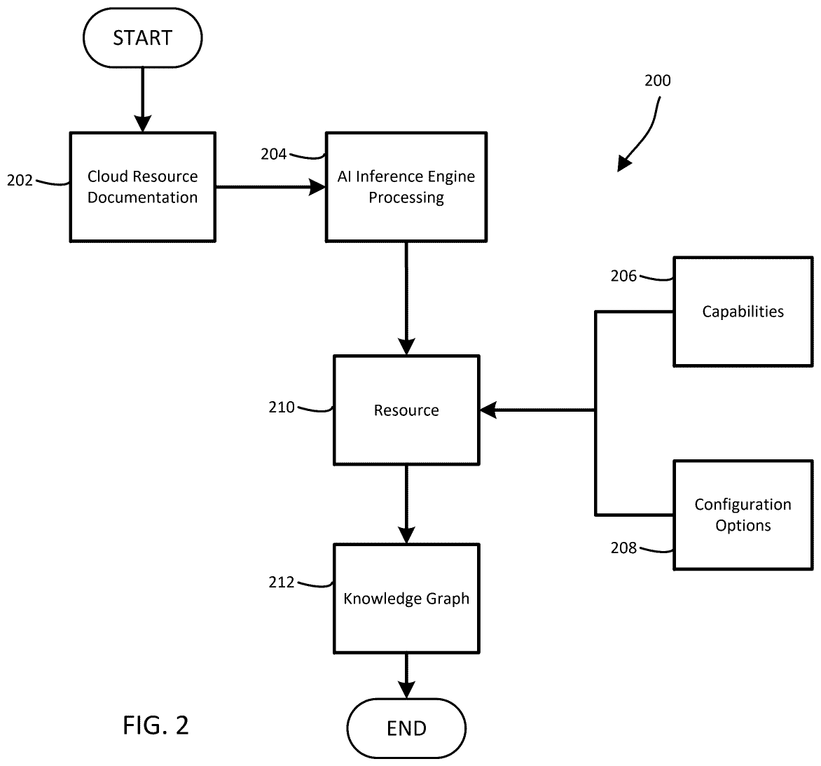

At 112, the method may include identifying whether the IaC contains any non-compliant resources. In some embodiments, identification of the non-compliant IaC resources may include executing one or more algorithms against the encoded expected related pattern to determine whether the parsed IaC matches the expected related pattern based on the policy statement, either completely or partially. If no non-compliant resources are identified, the system may continue processing and reviewing IaC. If non-compliant IaC is identified, the method may include resolving compliance with the policy statement at 116. In some embodiments, information from a knowledge graph 114 for the IaC may be combined with the identified non-compliant resources at 116 to resolve the compliance. In some embodiments, the knowledge graph may be a structured representation of information that may capture the relationships between various infrastructure components and configurations, such as entities (nodes) and relationships (edges). In some embodiments, the knowledge graph may be the knowledge graph generated as shown and described with reference to FIG. 2 herein. At 118, the method may include generating complaint IaC code to address the non-compliance identified at 112, and at 120, and the remediated IaC code may update to remediate the non-compliant resources to produce and deploy compliant IaC.

FIG. 2 shows and example flow chart representing an embodiment 200 of creating an updating a cloud knowledge graph, such as the knowledge graph 114 implemented and described in FIG. 1. In some embodiments, the steps of the method may be implemented by one or more processors on one or more computers or servers, and may be completed automatically with little or no manual input. In some embodiments, manual input may be provided for one or more steps of the method, or to confirm or verify one or more steps or features of the method. In some embodiments, cloud resource documentation 202 may be fed into an artificial intelligence (AI) inference engine for processing at 204. In some embodiments, cloud resource information may be cloud-stored or otherwise available information relating to one or more IaC tools that may be relevant to a particular application (e.g., Terraform, Ansible, AWS CloudFormation, Azure Resource Manager, etc.). In some embodiments, the cloud resource documentation 202 may include the different infrastructure resources that may be relevant to the particular IaC tool, such as virtual machines, databases, networks, security groups, etc. In some embodiments, the AI inference engine may apply a trained machine learning and/or AI model to the cloud resource data 202 to make inferences about the documentation. In some embodiments, the AI inference engine may be an AI and/or machine learning model specifically trained on known resource documentation data or other IaC resource data to optimize its ability to make inferences about unknown cloud resource documentation. In some embodiments, a resource 210 may be generated with inputs from the AI inference engine 204, as well as capabilities 206 and configuration options 208. In some embodiments, capabilities 206 may refer to specific functionalities of the IaC tool or framework being analyzed, which may be useful for defining, deploying, and/or maintaining infrastructure. For example, some capabilities may include provisioning, configuration management, orchestration, version control, compliance and security, monitoring and logging, etc. In some embodiments, configuration options 208 may refer to various settings and parameters that may be defined to manage and automate deployment and management of the IaC. For example, some configuration options may include declarative versus imperative configuration, modules, variables, outputs, dependencies, provisioners, state management, etc. The knowledge graph 212 may then be made up of multiple resources 210. In some embodiments, the individual resources 210 may be nodes to the knowledge graph at 212, with the edges to the knowledge graph representing how the resources in the knowledge graph connect and interact with each other. For example, in some embodiments, a knowledge graph might show how a web server (first node resource) may be connected to a database server (second node resource), the security rules governing their interaction (edges), and the dependencies on underlying network configurations.

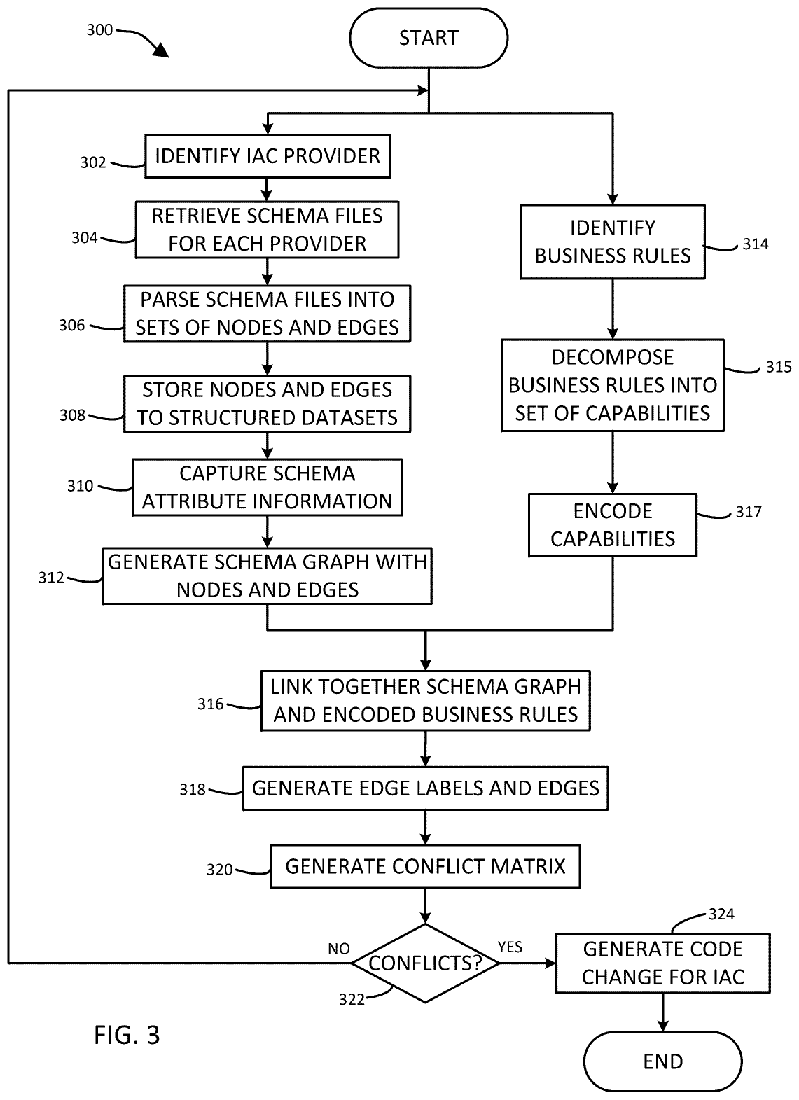

FIG. 3 is a flow chart 300 with additional detail related to embodiments of methods for implementing the deterministic automated IaC remediation systems and methods disclosed herein. In some embodiments, the steps of the method may be implemented by one or more processors on one or more computers or servers, and may be completed automatically with little or no manual input. In some embodiments, manual input may be provided for one or more steps of the method, or to confirm or verify one or more steps or features of the method. In some embodiments, the method may include, at 302 identifying one or more module providers or provider plugins for IaC or an IaC software tool (e.g., Terraform, Ansible, AWS CloudFormation, Azure Resource Manager, etc.). Once the providers and/or plugins may be defined, the method may include, at 304 retrieving one or more schema files (e.g., JSON files) for each provider/plugin. The schema files may define the structure, syntax, and validation rules for configuration files used to manage and provision infrastructure. The structure of the configuration files may include the required fields, data types, and hierarchical relationships between different elements, and the validation rules may define the rules for validating the configuration files. Shema files may also include descriptions and documentation for each field. For example, in some embodiments, the schema for a resource might define the required and optional attributes, the attribute types, and any constraints on the attribute values.

At 306, the method may include parsing the schema (JSON) file into a set of nodes and edges, which may be different for each schema file. In some embodiments, parsing the schema file may include extracting the structured data defined in the schema and identifying the entities (nodes) and the relationships (edges) between the nodes. At 308, nodes and edges may be saved as structured datasets, such as to spark tables (e.g., ML pipeline).

At 310, the method may include capturing all or substantially all schema attribute information, which may include data types. Capturing the attribute information may include transforming provider-specific or plug-in-specific representations into a graph-based representation. Attributes may define additional information about elements or objects within the schema, such as data type (e.g., string, integer), required, properties, default, pattern, minimum, maximum, etc. In some embodiments, virtually everything in the schema may be an attribute, and some attributes may also be arguments. In some embodiments, arguments may be parameters that define the properties and constraints of the data in the schema file, In some embodiments, arguments may be readable and settable, and attributes may just be readable. Capturing the schema attribute information may also include a normalization process from the language-specific representation of the data in the stored structured datasets into a graph-based representation. In some embodiments, for each resource in the schema, the method may include generating a representation in JSON or XML. In some embodiments, the definition of “argument” may be based on the values for “optional”, “computed”, and “deprecated.”

In some embodiments, at 312, a graph representation of the schema may be generated (i.e., schema graph), representing the schema into nodes and edges, such as (source label, source id), (target label, target id). A source may be a starting point of a connection or relationship between two nodes in the graph, and a target may be an endpoint of that connection or relationship (e.g., web server (source) initiating connection with a database (target). Labels may be the name and/or label for each node (e.g., web server, database server, user device, etc.), and id may be a unique identifier for the node (e.g. alphanumeric or numeric identifier such as node1, node1, etc.). In some embodiments, the files may be stored in a columnar storage file format, such as parquet format in s3, but may be based on other representations in other embodiments. In some embodiments, the method may include implementing a dynamic graph loading algorithm to select data in the columnar storage file to generate a graphical representation of the data. In some embodiments, the graph may be a cypherish graph, which may be based on openCypher.

At 314, the method may include identifying or otherwise retrieving business rules, such as a policy statement or framework. In some embodiments, the framework may be a set of business rules to be applied to the IaC, such as security policies or other guidelines. For example, one possible framework may be the NIST cyber security framework (CSF), which may be a set of guidelines and best practices designed to help organizations manage and reduce cybersecurity risks. Those skilled in the art will appreciate that this is just one example of the business rules that may be applied consistent with the disclosure.

In some embodiments, the method may include, at 315, decomposing the framework into a set of capabilities (e.g., security capabilities). In some embodiments, the method may include encoding the business rule capabilities at 317, which may include applying logical inferences to the ontological constructs that make up the business rules (e.g., policy statement 110 in FIG. 1). The logical inferences may be used to create a common vocabulary and establish relationships between different concepts. Application of the logical inferences identified may be accomplished by constructing code into the contextual scenarios representing each logical construct. In some embodiments, a valid state expected of the IaC plug-in or provider may be encoded based on the logical inferences drawn from the business rules. In some embodiments, the method may include encoding a specific rule that may translate into a specific parametrization of the IaC provider or plug-in at issue. Such encoding may represent a pattern from a policy schema that the system may automatically transform into an expected related pattern from an instance of infrastructure as code pertaining to the policy. In some embodiments, the encoded business rules capabilities and/or framework may be part of the knowledge graph described above in FIGS. 1 and 2 (i.e., policy statements 110), and may be represented in JSON.

With the decomposed schema graph and encoded business rules (e.g., security capabilities or other policies), the method may include, at 316, linking together the schema graph and the encoded business rule capabilities. In some embodiments, the linkage may occur by creating an ontology and using processing rules around the ontology to encode the graph. For example, the schema graph may include various edge types. For example, an edge type “IsExclusiveReferenceTo” may have an object with one sidecar object to which the object may be attached. In some embodiments, the linkage between schema and the business rules may occur by capturing the semantics of the relationship between resources and attributes in the schema with a set of generated relationship edges. The relationships edges my bear a certain meaning that may convey when a fix may apply.

Once a set of edge labels are created for the linked graph, the method may include, at 318, generating the edges. In some embodiments, creating edges for the linked graph may include determining a valid configuration and creating edges between the encoded capabilities and nodes in the schema graph. The implementation of an edge as applied to fixing the knowledge graph my involve implementing a match function and transpilation function. The match function may determine if a given rule should be applied to a particular knowledge graph scenario, and the transpilation function may determine how the current code implementation should be changed to meet the criteria defined in the business rule.

In some embodiments, linking of the schema graph and the encoded capabilities may include creating a schema cyphergraph. In some embodiments, the linking process may include queries that may capture how connections may be made between resources. In some embodiments, queries may be separated by their root node, and may be run against all resources in the schema graph. In some embodiments, the queries may build a set of configuration options that are valid. In some embodiments, soft brackets may be nodes, and hard brackets may be edges. In some embodiments, the business rules may be expressed in terms of the knowledge graph, conveying a certain query on the graph to determine if a fix is warranted. The query may also define the fix in that if the query does not match, then the {resource, edge, resource} (where an attribute may also be a resource) tuples may be interpreted to create a transpilation and replace existing code with new.

In some embodiments, the model of the code in the knowledge graph may be in the form of a directed acyclic graph (DAG) and may be thought as an abstract syntax tree (AST). The method may include, for each business rule, determining if the DAG applies, updating the DAG to contain appropriate changes (adding, removing, or changing elements) and transpiling the code back into the original language from the DAG.

In some embodiments, at 320, the method may include generating a conflict matrix (e.g., between resources in the schema graph and the encoded security capabilities), such as in databricks or another unified data platform. Conflicts may be resolved using one or more methodologies. For example, in some embodiments, the conflict matrix may identify that there may not be a particular key (e.g., a KMS key ID) equal to a particular string value or may be absent altogether. If a conflict occurs, the method may include identifying what may be conflicting in the conflict matrix and how to resolve the identified conflict. In some embodiments, for example, the method may include reading templates, such as customer templates (or other applicable templates for the particular set of IaC being analyzed) in the HCL syntax to build an abstract syntax tree (AST). In some embodiments, the method may include compiling an instance graph which may be compared with the schema graph previously generated. In some embodiments, the instance graph may create a set of nodes and resource calls.

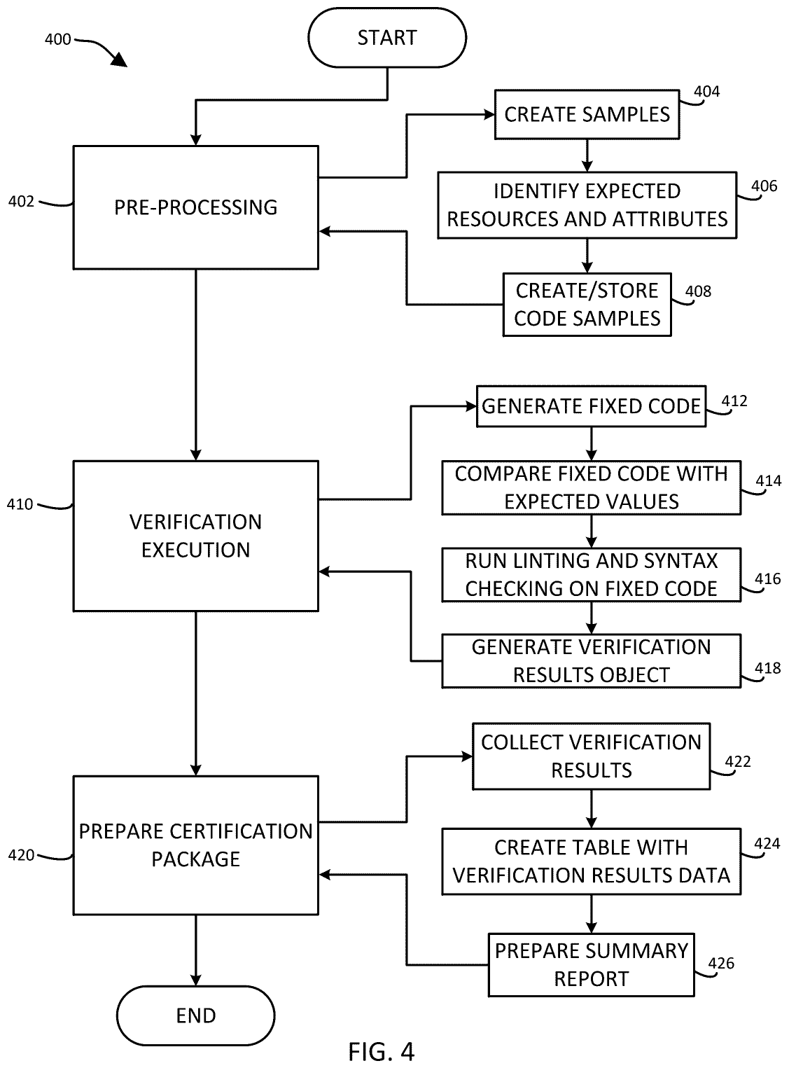

In some embodiments, a set of operations may be performed. For example, the method may include filtering out resources from the schema graph which have configuration options that are relevant, and selecting only those configuration options which may be chosen to apply. Such filtering may result in a configuration graph, which may be differentiated against the instance graph. At 322, the method may include determining the differences in the configuration graph and the instance graph and determining the changes needed to remediate conflicts identified in the IaC. Once the appropriate changes may have been determined, the method may include, at 324, the method may include generating the code change that may be used to remediate the IaC. In some embodiments, the method may include selecting one or more IaC configuration recommendations for fix verification and generating, by one or more processors, IaC code samples for which a configuration recommendation may be applicable based on the resources defined in the configuration recommendation. The method may include applying a fix to the sample IaC code, gathering diagnostic information to determine if the fix applied as expected or whether it encountered errors. In some embodiments, the method may include verifying the fix implementation by confirming that the resources and attributes that are part of the fix definition are updated appropriately in the fixed IaC code (see, e.g., the method 400 shown and described with reference to FIG. 4). In some embodiments, generating the remediation code may include applying the inverse of the process going from code to graph. In other words, the steps described above may be applied in reverse to get from the graphical representation of the remediated code back to the remediated code that may be applied to remediate the IaC being analyzed.

In some embodiments, the method 300 may additionally include steps for remediation verification as shown in the method 400 shown in FIG. 4. The method 400 may include pre-processing at 402, which may be for pre-verification inspection. In some embodiments, pre-processing may include creating samples at 404. Creating samples may include selecting a cloud service provider (e.g., Terraform, Ansible, AWS CloudFormation, Azure Resource Manager, etc.) and a benchmark (i.e., business rules per FIG. 3 and/or a policy statement) to pair with one another (i.e., service to check against a benchmark). For each cloud service provider, generate a default sample for the configuration of that cloud service and add that configuration to a main configuration file for the provider (e.g., main.tf file for Terraform). At 406, the method may include using a tuple (e.g., {cloud_service, config_option}) to identify the resources expected to be present (i.e., expected resources) and the attributes expected to be present (i.e., expected attributes). At 408, the method may include creating and storing code samples for each {config_option, benchmark_recommendation} tuple. In some embodiments, this may include generating provider (e.g., Terraform) code samples that may: (1) pass a provider's syntax and internal consistency check (e.g., Terraform validate) and (2) use a service for which the config option may apply. In some embodiments, the definition of a resource may be sufficient to show that the config option applies, even if no change is to be made. The method may then include storing the AI prompt and generated code samples with the benchmark recommendation.

At 410, the method may include verification execution. In some embodiments, verification execution may include, at 412, for each {config option, code sample} tuple, applying the configuration option to generate “fixed” code (i.e., output code configured to fix the identified mismatch with the benchmark). At 414, this may include comparing the generated code resources and attributes with the “excepted” values. In some embodiments, this may include a textual comparison of the output code and resource names. Verification execution may also include, at 416, running linting and syntax checking (e.g., such as tflint in Terraform) on the output code and storing the results. In some embodiments, certain types of errors may be ignored and the results may be considered valid even with those errors present. At 418, verification execution may also include generating a set of verification result objects (i.e., VerificationResult), which may include a diagnostics JSON object containing a set of diagnostic test values with a command run and an outcome.

At 420, the method may include preparing a certification package for each benchmark. At 422, this may include collecting the VerificationResult object for each benchmark recommendation. At 424, preparing the certification package may include creating a table with the VerificationResult data, which ma include a Recommendation ID, a Recommendation Title, a Recommendation Applicability (e.g., manual=false, automated=true), a Raw Verification Code Sample (input), an Updated Verification Code Sample (output), and a Verification Diagnostic Result (e.g., pass/fail for each check, an overall result of pass/fail depending on results). In some embodiments, preparing the certification package may also include preparing a summary report of the verification results that may include information for confirming that verification may have occurred and been successful or not successful.

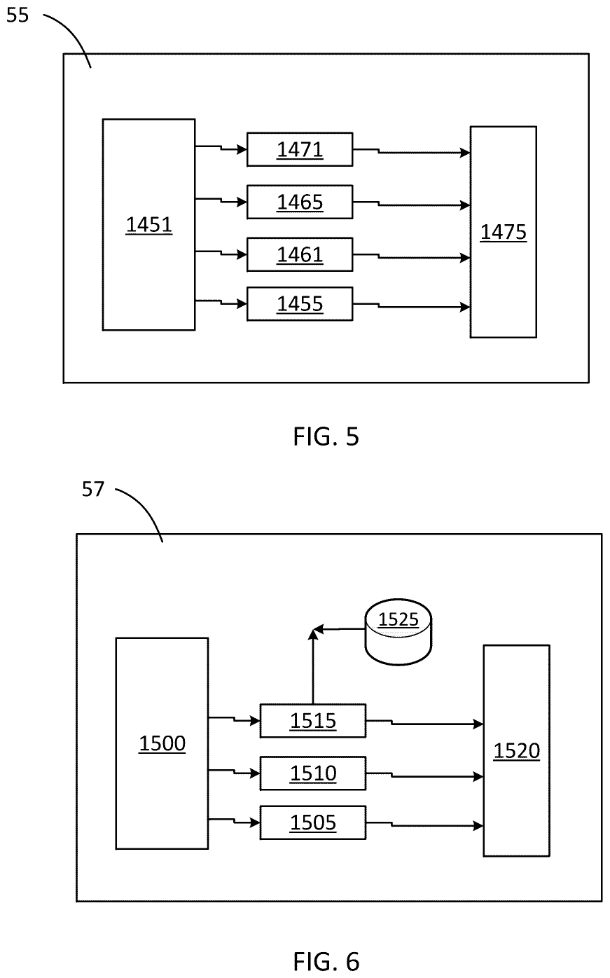

FIG. 5 is a simplified illustration of some physical elements that may make up an embodiment of a computing device 55 and FIG. 6 is a simplified illustration of the physical elements that make up an embodiment of a server type computing device, both of which may be used to run one or more aspects of the deterministic automated IaC remediation system described herein. Referring to FIG. 5, a sample computing device is illustrated that is physically configured to be part of the deterministic automated IaC remediation system. For example, the computing device 55 may be a node within a schema graph or have other computing functionality as described herein. The computing device 55 may have a processor 1451 that is physically configured according to computer executable instructions. In some embodiments, the processor may be specially designed or configured to optimize communication between a server relating to the deterministic automated IaC remediation system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server 57, such as a remote cloud server or other server on a network, are further illustrated in FIG. 6. In some embodiments, the server may be specially configured to run the deterministic automated IaC remediation system disclosed herein, either remotely, locally, on a distributed cloud computing system, etc., At a high level, the server 57 may include a digital storage such as a magnetic disk, an optical disk, flash storage, non-volatile storage, etc. Structured data may be stored in the digital storage database. More specifically, the server 57 may have a processor 1500 that is physically configured according to computer executable instructions. In some embodiments, the processor 1500 can be specially designed or configured to optimize communication between servers or cloud servers storing business rules, IaC code, servers run by IaC tool providers or plug-ins, etc., as described herein. The server 57 may also have a sound and video module 1505 which assists in displaying video and sound and may turn off when not in use to conserve power and battery life. The server 100 may also have volatile memory 1510 and non-volatile memory 1515.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of automatic infrastructure as code (IaC) remediation, the method comprising:
retrieving a schema file for one or more IaC providers, the schema files including IaC code;
parsing, by one or more processors, the one or more schema files into sets of nodes and edges;
capturing, by the one or more processors, schema attribute information for each of the schema files;
generating, by the one or more processors, a graph representation of the schema files based on the parsed nodes and edges and the schema attribute information;
identifying one or more sets of business rules;
linking, by the one or more processors, the graph representation of the schema files with the one or more sets of business rules;
generating, by the one or more processors, a conflict matrix based on one or more differentiations between the graph representations of the schema files and the one or more sets of business rules;
verifying, by the one or more processors, an outcome of applying a code change based on the one or more differentiations; and
based on the verification, generating code changes for the IaC code.

2. The method of claim 1 further comprising storing the nodes and edges as structured datasets.

3. The method of claim 1, wherein the schema files define one or more of structure, syntax, and validation rules for configuration of the IaC code.

4. The method of claim 1, wherein the nodes may be one or more resources of the IaC code and the edges may be relationships between the one or more resources.

5. The method of claim 1, wherein the one or more schema file may be a JavaScript Object Notation (JSON) file.

6. The method of claim 1 further comprising decomposing the one or more sets of business rules into a set of capabilities.

7. The method of claim 6 further comprising encoding a valid expected state of the IaC code for each capability in the set of capabilities.

8. The method of claim 7, wherein linking the graph representation of the schema files with the one or more sets of business rules includes comparing the graph representation of the schema files with the valid expected state of the IaC code.

9. The method of claim 8, wherein the one or more differentiations between the graph representations of the schema files and the one or more sets of business rules are differences between the graph representations of the schema files and the valid expected state of the IaC code.

10. A computer-implemented method of automatic infrastructure as code (IaC) remediation, the method comprising:
encoding, by one or more processors, one or more policy statements;
parsing, by the one or more processors, IaC code to generate resources and configuration sets for the IaC code;
intersecting, by the one or more processors, the encoded one or more policy statements with the resources and configuration sets;
identifying, by the one or more processors, one or more non-compliant IaC resources based on differentiations between the encoded one or more policy statements with the resources and configuration sets;
verifying, by the one or more processors, an outcome of applying a code change based on the differentiations; and
generating, by the one or more processors, remediated IaC code to remediate identified non-compliant IaC code.

11. The method of claim 10, wherein generating the remediated IaC code further comprises incorporating information from a knowledge graph.

12. The method of claim 11, wherein the knowledge graph includes capabilities and configuration options for the IaC code.

13. The method of claim 11 further comprising generating the knowledge graph by applying an artificial intelligence (AI) inference engine to resource documentation corresponding to the IaC code.

14. The method of claim 10, wherein the resources and configuration sets include one or more of entities defined within the IaC code, configuration files, storage resources, security resources, or compute resources.

15. The method of claim 10, wherein encoding the one or more policy statements includes applying, by the one or more processors, logical inferences to ontological structures of the one or more policy statements.

16. The method of claim 10, wherein encoding the one or more policy statements includes constructing code into contextual scenarios of one or more logical constructs of the one or more policy statements.

17. A method of automatic infrastructure as code (IaC) remediation, the method comprising:
retrieving a schema file for one or more IaC providers, the schema files including IaC code;
parsing, by one or more processors, the one or more schema files into sets of nodes and edges, wherein the nodes may be one or more resources of the IaC code and the edges may be relationships between the one or more resources;
storing, by the one or more processors, the sets of nodes and edges in structured datasets;
capturing, by the one or more processors, schema attribute information for each of the schema files;
generating, by the one or more processors, a graph representation of the schema files based on the parsed nodes and edges and the schema attribute information;
identifying one or more sets of business rules;
generating, by the one or more processors, a set of capabilities for the one or more sets of business rules;
encoding, by the one or more processors, a valid expected state of the IaC code for each capability in the set of capabilities as an expected graph;
linking, by the one or more processors, the graph representation of the schema files with the one or more sets of business rules by comparing the graph representation of the schema files with the expected graph;
generating, by the one or more processors, a conflict matrix based on one or more differentiations between the graph representation of the schema files with the expected graph;
verifying, by the one or more processors, an outcome of applying a code change by analyzing the expected graph compared to the graph representation of the schema files; and
based on the differentiations in the conflict matrix, generating code changes for the IaC code.

18. The method of claim 17, wherein the one or more schema file may be a JavaScript Object Notation (JSON) file.

19. The method of claim 17, wherein the set of capabilities is generated by decomposing the one or more sets of business rules.

20. The method of claim 17, wherein generating the set of capabilities of for the one or more sets of business rules includes applying, by the one or more processors, logical inferences to ontological structures of the one or more sets of business rules.
